(19) United States
(12) Patent Application Publication
(10) Pub. No.: US 2017/0028669 A1
(43) Pub. Date: Feb. 2, 2017

(54) COMPRESSIBLE, LOW-WEIGHT INSULATION MATERIAL FOR USE IN GARMENTS

(71) Applicant: Patagonia, Inc., Ventura, CA (US)

(72) Inventors: Christian S. Regester, Ventura, CA (US); Gary M. Paudler, Ventura, CA (US)

(21) Appl. No.: 14/814,353

(22) Filed: Jul. 30, 2015

(51) Int. Cl. B32B 3/26; A41D 3/00; A41D 31/02; B32B 3/30

(52) U.S. Cl. CPC B32B 3/266; B32B 3/30; A41D 3/00; A41D 31/02; B32B 2307/51; B32B 2307/304; B32B 2437/00

(57) ABSTRACT

A compressible insulating material for use in active garments and other gear is provided herein. The material comprises an insulating material including one or more types of fiber, with portions of the insulating material removed or cut to improve the warmth-to-weight and compression characteristics of the insulating material. In some embodiments, the insulating material is an elastic insulating material that defines perforations or other features that expand or contract depending on stretching or relaxation of the elastic insulating material. Stretching and relaxation may vary an insulating property of the compressible, low-weight insulating material. The material may further be secured to a stretch-resistant material to provide a reference point for stretching and for and elastic memory. A garment comprising one or more panels of a compressible, low-weight insulating material as described herein is also provided. Strategic placement of the insulating material can improve ventilation of the garment during activities.

### FIELD OF THE INVENTION

This invention relates generally to insulation materials for use in athletic and other active garments, and more specifically to compressible, low-weight insulation materials with elastic memory that define variable or irregular surfaces for improved modulation of heat, moisture, and air exchange in use and at rest. The invention may also find application in medical support fabrics or dressings.

### BACKGROUND OF THE INVENTION

For those engaged in cold-weather activities such as mountaineering, ice climbing, skiing, snowboarding, alpine rescue, outdoor work, and the like, it is essential that gear be at once functional and feasible. For example, properly insulated garments and sleeping bags are necessary for safety and thermal comfort in challenging environments, but a balance must be struck between warmth and other factors, such as the weight, packability, and breathability/air permeability (i.e., transmission of air and moisture vapor) of the garment.

A garment that is excessively heavy or warm, or that has sub-optimal breathability, can result in lost energy and efficiency, thereby decreasing user performance, detracting from the enjoyment of the activity, and potentially increasing safety risks in high-consequence situations. Weight is a particularly important factor when designing insulation for active gear. Thus, insulated garments that strike an optimal balance between warmth provided and material weight are desirable.

The thermal insulation value of a given clothing material is often reported in “do” units. By way of illustration, one do unit allows a sedentary person at 1 met (the Metabolic Equivalent of Task, or the rate of energy produced per unit surface area of an average person at a given task) to remain indefinitely comfortable in an environment of approximately 70° F., 50% relative humidity and 0.01 m/s of air movement. Above that temperature, a person so dressed will be uncomfortably warm, and below that temperature, they will be uncomfortably cold. See, for example, The Engineering Toolbox, Clo—Clothing and Thermal Insulation (Jun. 30, 2015), http://www.engineeringtoolbox.com/clo-clothing-thermal-insulation-d_732.html; Saeed Moaveni, “Engineering Fundamentals: An Introduction to Engineering” Cengage Learning 377 (2015).

Accordingly, materials with higher do values attain and maintain thermal comfort for a user more efficiently than materials with lower do values. A relatively small amount of high-clo insulation may keep the wearer of a garment comfortable without adding undesirable weight to the garment, while a correspondingly high amount of low-clo insulation, with an attendant increase in garment weight, is needed to achieve the same level of comfort. Users of active gear prefer to focus their energy on performance and on enjoying the experience, rather than wearing, carrying, or otherwise transporting excess gear weight. Thus, providing garment insulation with improved do values is an important objective in designing active gear products.

Traditionally, down fill (e.g., goose down) has been valued for its warmth-to-weight ratio (i.e., down possesses a relatively high do value), which has generally been superior that of synthetic insulation materials. However, down fill suffers from a number of shortcomings, including migration (movement of down fill to a localized portion of an insulated chamber, resulting in uneven insulation and cold spots), protrusion of the down shaft through an interior or exterior garment layer, and a poor capacity to manage and/or transport moisture. Many users are familiar with down-filled garments becoming heavy, soggy, and cold when exposed to even moderate amounts of water. Such water exposure may come in the form of rain, wet snow, running water, ambient humidity, or perspiration that is generated during strenuous activities. When this occurs, the heat-trapping structures of the down plumes collapse, decreasing the do value and rendering the down effectively unfit for providing warmth. Excessive moisture can also substantially increase the weight of down, making down a poor, potentially life-threatening choice if conditions are uncertain or may become wet. Additionally, products featuring down fill typically require special care and costly reagents for cleaning. More recently, ethical concerns have arisen regarding some down-gathering practices.

Synthetic insulation materials provide an alternative to down fill. Such materials are typically constructed of polyester fibers that are molded into long, durable threads, or into short clusters that provide insulating loft. Synthetic insulation materials possess numerous advantages over down, including lower cost, improved water resistance, improved do value when wet, and quicker drying time. However, as mentioned, traditional synthetic insulation materials possess a low warmth-to-weight ratio when compared to down. Thus, more synthetic material is required to achieve thermal comfort, resulting in a heavier, bulkier garment. Therefore, alternative insulating concepts are needed.

Another concern for outdoor enthusiasts and those performing cold-weather tasks is how well a piece of gear “packs down” (e.g., “pack volume”) for efficient storage and transportation, both during and between activities. This is particularly important in the field, where a storage means (e.g., a backpack) is limited in size so that it may be comfortably worn or carried and used. As used herein, the term “compression profile” refers to the minimal amount of 3-D space an insulated product occupies when compressed by a user. Thus, the less space the insulated product can be made to occupy, the lower its compression profile.

By minimizing the compression profile of a given insulated item, a user is able to more easily transport additional items that may be necessary for a safe, enjoyable, and productive activity. While some down-filled garments may be packed to occupy a relatively small space, the aforementioned issues of down migration, protrusion of the down shaft through the garment exterior, and the slow drying time of wet down detract from the packability of down-filled garments. On the other hand, known synthetic garment insulations require more material to provide thermal comfort, resulting in decreased free air space and increased density. Such synthetic materials resist compression, resulting in subpar packability. Thus, insulating materials with improved (i.e., decreased) compression profiles for storage and transport are desirable.

Optimized management of moisture and airflow in a garment is another consideration for designers and users of active garments. As mentioned, strenuous activities such as ice climbing, ski touring, outdoor work, and the like can generate substantial body heat and increase humidity beneath an insulated garment. Excessive heat and humidity can be highly uncomfortable to the user and may result in further loss of fluids, heavier garments, and, often, intense cold when the user comes to a resting point in a cold environment. While strategic layering of wicking, insulating, and exterior materials is a common approach to this problem, wearing and changing multiple layers can be inefficient and cumbersome. Thus, materials are needed that efficiently manage inflow and outflow of heat, air, and moisture relative to the garment, while providing a desired degree of insulation. Preferably, such materials are also relatively lightweight and may be advantageously packed down for transport or storage.

### SUMMARY OF THE INVENTION

Against this backdrop, the present invention has been created. In one aspect of the present invention, a compressible, low-weight insulating material includes an insulating material, wherein portions of the insulating material are removed or penetrated and cut (such as with a slit) so as to provide increased breathability and/or warmth-to-weight ratio and a decreased compression profile relative to the insulating material when fully intact. Portions of the insulating material may be removed, such that the insulating material provides the same or an increased amount of warmth with a lesser amount of insulating material present. Alternatively or in addition, portions of the insulating material may be penetrated or cut to create negative space or a passageway within the insulating material. Warm air may collect in the negative space, increasing the warmth conferred on the user by the same amount of insulating material. During activities, the cuts or slits may allow overly hot air and moisture to more easily escape.

In certain embodiments, the insulating material is an elastic material, such as a polyester fiber material, that defines an inner surface and an opposing outer surface. One or more portions of at least one of the inner and outer surfaces is removed or penetrated so as to increase heat transfer when the elastic insulating material is stretched and to decrease heat transfer when the elastic insulating material is at rest. In certain embodiments, the insulating material of the present invention may be formed of a single layer of an elastic insulating material. In other embodiments, the insulating material may include two or more layers formed of one or more elastic insulating materials. An outer water-resistant layer may be joined, for example, to an insulating material.

In various embodiments, polyester fibers of the elastic insulating material may be adapted for improved elasticity. For example, in certain embodiments, the polyester fibers may define one or more bends, kinks, swirls, coils, branches, and the like, such that a given fiber may overlap and/or engage with at least a portion of an adjacent fiber. When the elastic insulating material is stretched, the bends, kinks, swirls, or coils defined along a given fiber may partially or fully straighten while retaining elastic memory. When the elastic insulating material relaxes from a stretched state, the collective elastic memory of the engaged fibers facilitates a return to original length and configuration, including any bends, kinks, swirls, or coils. In certain embodiments, the elastic insulating material is a non-woven material. In other embodiments, the elastic insulating material is a knit material. In certain embodiments, the elastic insulating material includes a single material. In other embodiments, the elastic insulating material includes at least two different materials.

In some embodiments, one or more portions of the elastic insulating material is removed or penetrated to form perforations that run from an inner surface, through the elastic insulating material, to an opposing outer surface. In other embodiments, one or more recesses may be formed in at least one of an inner and an opposing outer surface of the elastic insulating material. In yet other embodiments, a slit is formed in at least one of an inner and an opposing outer surface of the elastic insulating material. It will be appreciated that a given material may include any one of, or at least two of, a perforation, a recess, or a slit, as well as other features described herein.

The perforations, recesses, or slits may assume the form of ovals, circles, crescents, scallops, mustaches, or other shapes, including polygons such as hexagons, rectangles, stars, squares, pentagons, heptagons, octagons, triangles, and the like. The perforations, recesses, or slits may be of consistent shapes or sizes or may be of varying shapes or sizes.

Due to the elastic nature of the insulating material and the shape or shapes of the various features defined therein, the perforations, recesses, or slits can widen when stretched and close when relaxed, thereby regulating heat transfer and ventilation in accordance with the movement of the elastic insulating material. The perforations, recesses, or slits are bounded and defined by walls of the interior elastic insulating material. Opposing walls of a given perforation, recess, or slit may be parallel to one another, substantially parallel to one another, or skewed or divergent with respect to one another.

For example, in certain embodiments, opposing walls of a given perforation are parallel to one another. In other embodiments, opposing walls may orient toward one another from an inner surface to an opposing outer surface of the elastic insulating material, thereby defining a perforation or a recess in the shape of a cone, a triangle, or a polyhedron such as, for example, a pyramid. A perforation, recess, or slit may travel either a linear path or a nonlinear or tortuous path through the elastic insulating material. It will be appreciated that a perforation, recess, or slit may define any number of shapes as it travels partially or completely through the elastic insulating material. For example, the perforation, recess, or slit may undulate, or spiral, or zigzag, or may form an hourglass shape as it travels through the elastic insulating material.

In certain embodiments, the perforation, recess, or slit is planar or substantially planar relative to the elastic insulating material (i.e., assuming the shortest path from the inner surface to the opposing outer surface). In other embodiments, the perforation, recess, or slit is nonplanar relative to the elastic insulating material (i.e., assuming a path through the elastic insulating material that is longer than the distance between the inner surface and the opposing outer surface).

A perforation, recess, or slit may be the same size, substantially the same size, or a different size at the inner surface of the elastic insulating material as at the outer surface of the elastic insulating material. For example, in certain embodiments, the interior walls forming the perforation, recess, or slit are parallel or substantially parallel to one another, resulting in a perforation, recess, or slit that is the same size, or substantially the same size, at the inner and outer surfaces of the elastic insulating material. For example, in various embodiments, the size of the perforation, recess, or slit at the outer surface may be from 75-100%, from 80-100%, from 85-100%, from 90-100%, from 95-100%, or from 99-100% the size of the perforation, recess, or slit at the inner surface. In other embodiments, the size of the perforation, recess, or slit a the outer surface may be less than 75% the size of the perforation, recess, or slit at the inner surface.

In another aspect of the present invention, an elastic insulating material defines an inner surface and an opposing outer surface. At least one of the inner surface and the opposing outer surface is adapted to decrease heat transfer across the elastic insulating material when stretched and to increase heat transfer across the elastic insulating material when relaxed.

In various embodiments, at least one of the inner surface and the outer surface is adapted to form a protrusion that expands away the given surface when the elastic insulating material is stretched. This increases the loft of the elastic insulating material, promoting retention of heat, moisture, and air. When the elastic insulating material is relaxed, the protrusion contracts toward the given surface, decreasing the loft of the elastic insulating material and promoting transfer of heat, moisture, and air. When used in a garment, the elastic insulating material of the present aspect may be disposed between a layer of an outer material and a layer of an inner material, the outer and inner layers serving to retain warm air trapped within the lofted insulation. In some embodiments, the outer material is a nonporous material.

In an embodiment, at least one of the inner surface or the outer surface defines a scallop-shaped slit with lobe elements. When the elastic insulating material is stretched, the lobes expand and protrude away from the given inner or outer surface, thereby increasing the loft of the elastic insulating material. When the elastic insulating material relaxes, the lobes contract towards the given inner or outer surface, thereby decreasing the loft of the elastic insulating material. Those of skill in the art will appreciate that recesses and protrusions of various other shapes and designs may be employed to variably increase or decrease the loft of the elastic insulating material without departing from the true scope and spirit of the invention.

It will be further understood that an insulating material of the present invention with recesses or slits defined along only one surface may be less elastic than (i.e., will not stretch as well as) an insulating material with recesses and slits defined along both of an inner surface and an opposing outer surface, or than an insulating material wherein perforations defined through the elastic insulating material from an inner surface to an opposing outer surface.

In various embodiments, the perforation, recess, slit, or protrusion may be formed by use of a laser as is known in the art. Use of a laser may confer the additional benefit of fusing together elastic insulating fibers that are in close proximity to the perforation, recess, slit, or protrusion. Being fused, the fibers may exhibit improved tensile strength and elastic memory, resulting in a more durable and responsive insulating material. The perforation, recess, slit, or protrusion may also be formed by use of a cutting die, such as a hot die, or another edged tool. A penetration may be made by, for example, a blade, a pin, a laser, a waterjet, or any other appropriate pointed tool for penetrating the elastic insulating material. Alternatively, the elastic insulating material may be manufactured using known techniques to define apertures, recesses, slits, scored lines, or protrusions, rather than being perforated, penetrated, scored, etched, or cut.

In another aspect of the present invention, a garment comprises a compressible, low-weight insulating material as disclosed herein. The compressible, low-weight insulating material may include one or more of the foregoing perforations, recesses, slits, scored lines, or protrusions. In some embodiments, the garment comprises an inner material layer, an outer material layer such as a shell layer, and layer of a compressible, low-weight insulating material. In other embodiments, the garment may comprise an outer layer, such as a waterproof outer fabric with a breathable liner, and a compressible, low-weight insulating material of the present invention. It will be appreciated that various constructions of a garment comprising a compressible, low-weight insulating layer of the present invention may be achieved without departing from the true scope and spirit of the invention.

The garment may be, for example, a jacket, a base layer garment, a pair of pants, a sock, a hat, a facemask or balaclava, a glove, a blanket, a sleeping bag, or the like. Panels of the compressible, low-weight insulating material may be placed in areas of the garment that correspond to those portions of a wearer's body that move, stretch, and/or generate heat during activities. Such areas may include, for example, the underarm and back areas of a jacket, the thigh area of a pant leg, the mouth and crown areas of a facemask or balaclava, the foot of a sock, and the foot box of a sleeping bag.

Multiple panels of a compressible, low-weight insulating material of the present invention may be placed at different locations along an insulating layer of a garment such that movement by a wearer of the garment creates a pumping or “billowing” effect. For example, perforated panels of the compressible, low-weight insulating material may be placed on along the outer or inner thigh of each leg of a ski pant. As a wearer of the ski pant performs skiing and walking activities, the various perforated insulating panels expand and contract to pump and circulate air and heat within and without the pant. Increased air circulation across the interior of the garment and from the interior of the garment to the outside environment may relieve or prevent undesirable buildup of heat and moisture.

### BRIEF DESCRIPTION OF THE DRAWINGS

Preferred and alternative examples of the present invention are described in detail below with reference to the following drawings:

FIG. 1A is a front-elevational view of an embodiment of the compressible, low-weight insulating material of the present invention in relaxed state. A series of perforations and/or recesses vary in size along a gradient defined by arrow A.

FIG. 1B is a front-elevational view of another embodiment of the compressible, low-weight insulating material of the present invention in a stretched state.

FIG. 1C depicts (at left) a front-elevational view and (at right) a side-elevational view of another embodiment of the compressible, low-weight insulating material of the present invention in a stretched state.

FIG. 1D depicts (at left) a front-elevational view and (at right) a side-elevational view of another embodiment of the compressible, low-weight insulating material of the present invention in a stretched state.

FIG. 2A depicts an isometric view of another embodiment of the compressible, low-weight insulating material of the present invention in a relaxed state.

FIG. 2B depicts the embodiment shown in FIG. 2A in a stretched state.

FIG. 3A is a front-elevational view an embodiment of the compressible, low-weight insulating material of the present invention in a relaxed state. The insulating material is attached to a more rigid material.

FIG. 3B is the embodiment shown in FIG. 3B in a stretched state.

FIG. 4A is a front-elevational view of an insulated garment layer of the present invention.

FIG. 4B is a rear-elevational view of the insulated garment of FIG. 4A.

FIG. 4C is a left side-elevational view of the insulated garment of FIG. 4A with the left arm of the garment raised.

FIG. 5 is a front-elevational view of an insulated garment of the present invention with a portion of the left underarm cut away to reveal a multi-layer construction.

### DETAILED DESCRIPTION OF THE PREFERRED EMBODIMENTS

The problem of striking a desirable balance between the weight, insulating properties, and compressibility of an insulating material may be solved by use of a compressible, low-weight insulating material of the present invention, wherein certain portions of an insulating material are removed so as to provide an increased warmth-to-weight ratio and a decreased compression profile relative to the insulating material when fully intact.

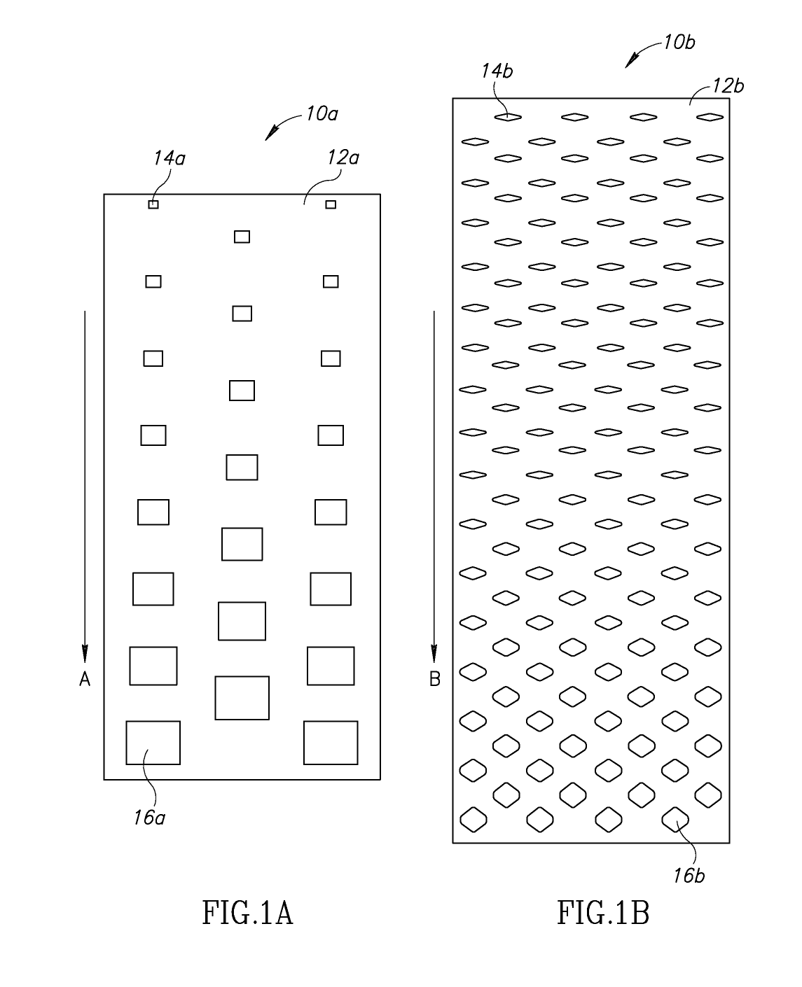

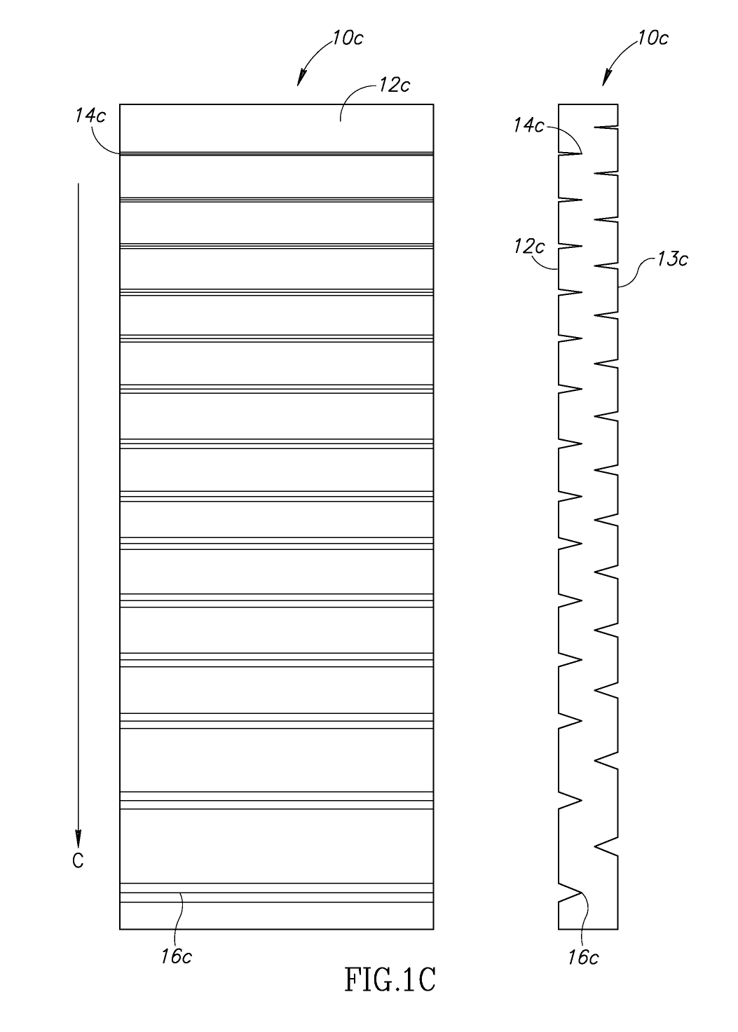

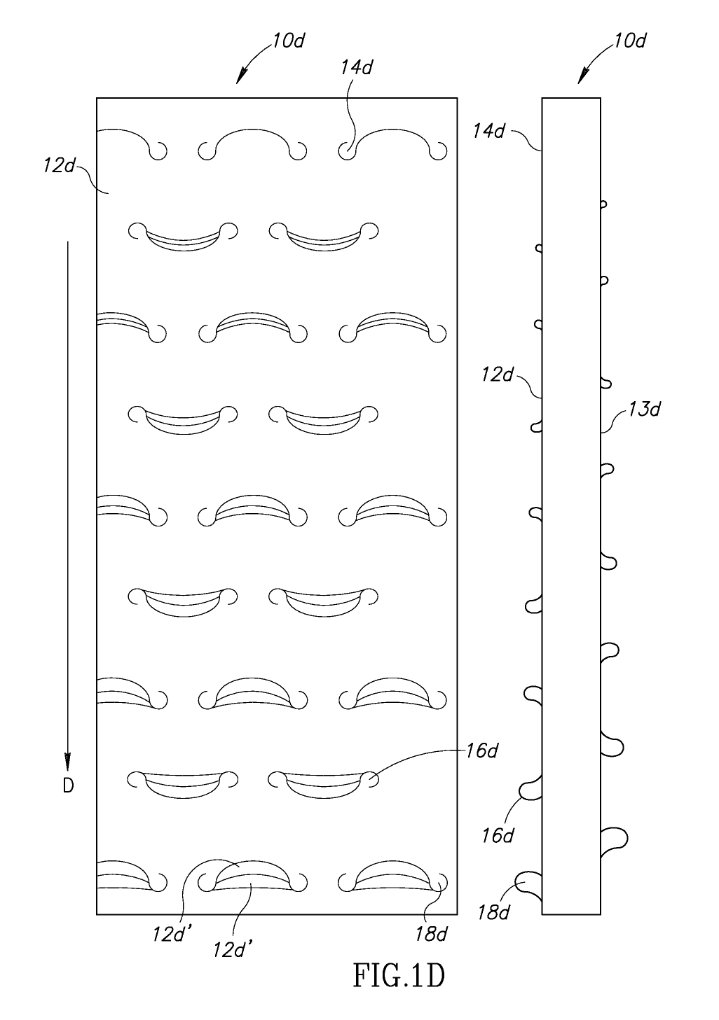

In certain embodiments, the insulating material is an elastic insulating material with portions thereof removed such that an insulating property of the elastic insulating material varies with stretching and relaxation of the elastic insulating material.
FIG. 1A depicts a front-elevational view of a compressible, low-weight insulating material 10a of the present invention in a relaxed (i.e., non-stretched) state. A surface 12a of an elastic insulating material defines a plurality of rectangular perforations along a size gradient in the direction of arrow A from smallest (e.g., 14a) to largest (e.g., 16a). As is discussed below with reference to FIG. 1B, the perforations permit variable insulation during stretching and relaxation of the insulating material 10a. Further, the negative space defined by the perforations permits improved compression of the insulating material 10a. It will be appreciated that in order to improve the elasticity of a given portion of the insulating material, a greater number of smaller perforations may be advantageous over a smaller number of larger perforations. Additionally, where the insulating material is disposed between other layers of a garment, smaller perforations may provide the advantage of preventing the layers adjacent to either surface of the insulating material from contacting one another through the perforations.

FIG. 1B depicts a front-elevational view of another compressible, low-weight insulating material 10b of the present invention. A surface 12b of an elastic insulating material defines a plurality of diamond-shaped perforations (e.g., 14b, 16b). In contrast to FIG. 1A, FIG. 1B depicts the compressible low-weight material 10b being pulled and stretched in the direction indicated by arrow B. Thus, stretching the insulating material 10b in the direction of arrow B opens and enlarges perforation 16b relative to perforation 14b.

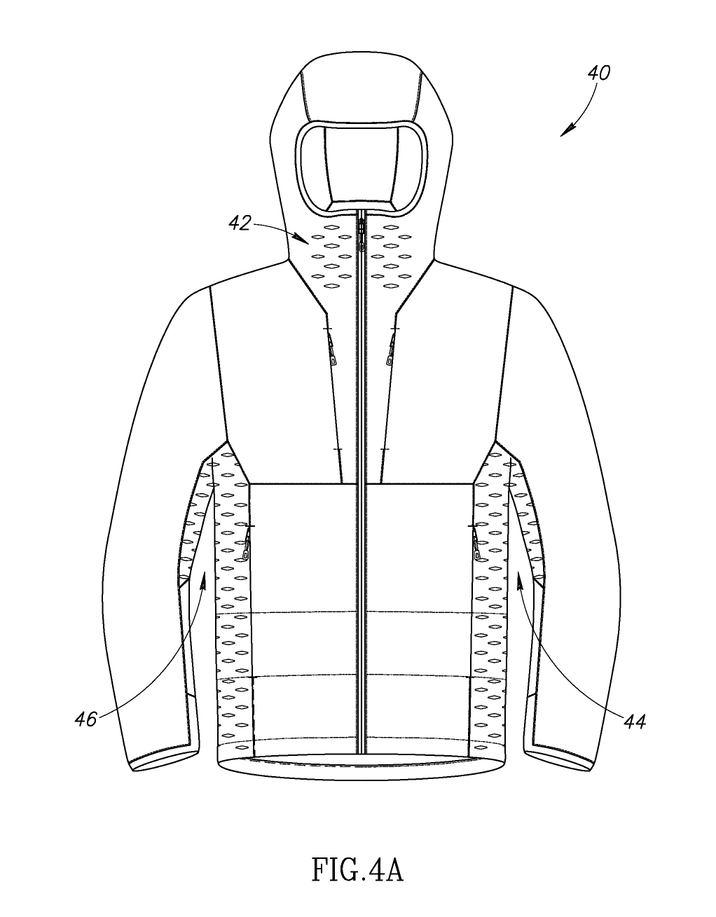

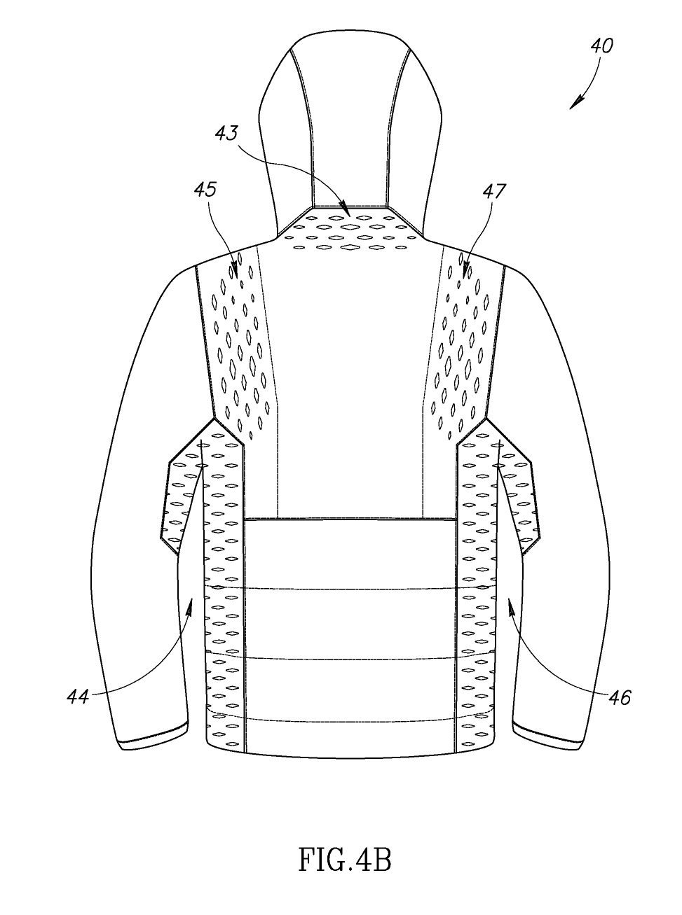

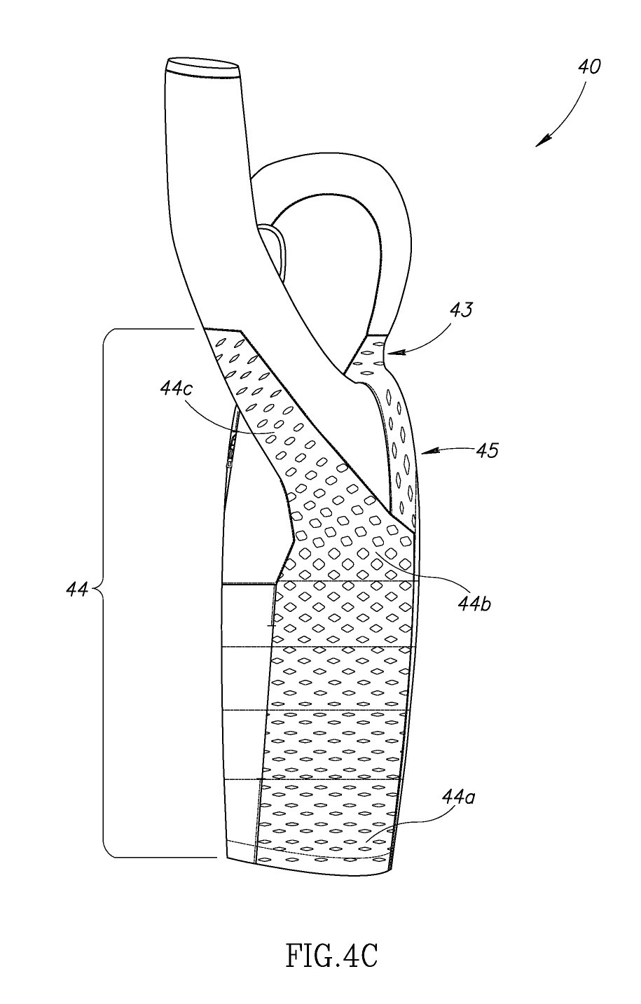

The insulating material 10b may form the construction of a garment such as a jacket. During physical activity such as clearing snow, rock climbing, or skiing, the motions of the wearer stretch and relax the insulating material 10b. As is further discussed with reference to FIGS. 4A-4C, a compressible insulating material of the present invention may open during strenuous activities to increase transfer of heat and/or moisture, while closing at rest to retain heat along an inner surface of the insulating material 10b (e.g., the side of a garment that is closest to the wearer's body).

In other embodiments, the elastic insulating material is removed by scoring to create scored lines on at least one of the inner and outer surfaces. The scored lines define negative spaces or “valleys.” FIG. 1C depicts a compressible, low-weight insulation material 10c wherein portions of an elastic insulating material have been removed by scoring to produce a plurality of scored lines (e.g., 14c, 16c) along both an outer surface 12c and an opposing inner surface 13c of the elastic insulating material. At left is a front-elevational view of the insulation material 10c. At right is a side-elevational view of the insulation material 10c. In this example, the insulation material 10c is stretched in the direction of arrow C.

The scored lines defined along each of the outer 12c and inner 13c surfaces are offset relative to the scored lines defined along the opposing surface. As the insulating material 10c is stretched in the direction of arrow C, the recesses or valleys defined by the scored lines widen, enlarging the negative space defined by the scored lines and permitting increased transfer of heat, moisture, and/or air. For example, the insulating material 10c will retain more heat at scored line 14c than at scored line 16c when the insulating material 10c is stretched in the direction of arrow C. In other embodiments, only one of an inner surface or an opposing outer surface, or a portion thereof, may be scored. A scored line may further define one or more perforations, and it may also define recesses of shapes other than those shown in FIG. 1C. In various embodiments, a compressible, low-weight material of the present invention may comprise both perforations and scored lines.

FIG. 1D depicts front-elevational view (left) and side-elevational view (right) of another embodiment of a compressible, low-weight insulating material 10d of the present invention. In this embodiment, outer 12d and inner 13d surfaces of the insulating material 10d define a plurality of nonlinear slits that assume a “mustache” or “scalloped” shape. Each slit defines at least one lobe (e.g., 14d, 16d, 18d) that is configured and arranged to protrude above the respective outer 12d or inner 13d surface as the insulating material 10d is stretched in the direction of arrow D. In FIG. 1D, slits in alternating rows are cut in opposing directions. For example, the slit defining lobe 18d mirrors the slit defining lobe 16d. As the insulating material 10d is stretched in the direction of arrow D, the slit widens to expose interior insulation material 12d′ adjacent to the slit. Due to the shape of the slits and the continuity of the insulating material 10d beneath the slit, stretching the insulating material 10d causes the lobes to rise and protrude away from the respective outer 12d or inner 13d surface.

As can be seen in the side-elevational view at right of FIG. 1D, lobes 16d and 18d are proximate to the source of stretching tension (i.e., the pulling source) and protrude above the outer surface 12d of the insulating material 10d. Greater protrusion of the lobes increases the loft and the effective surface area of the insulating material 10d, thereby lengthening the path that heat, moisture, and/or air must travel from the inner surface 13d to the outer surface 12d. For example, the loft and effective surface area of the insulating material 10d is increased in the direction of stretching from lobe 14d to lobes 16d and 18d. By contrast, lobe 14d is distal to the direction of stretching and, as a result, is flush with the outer surface 12d in the side-elevational view at right of FIG. 1D. Relaxation of the insulating material 10d closes the slits, releasing tension on the lobes and returning the lobes (e.g., 16d, 18d) to proximity with the respective outer 12d and inner 13d surfaces of the insulating material 10d.

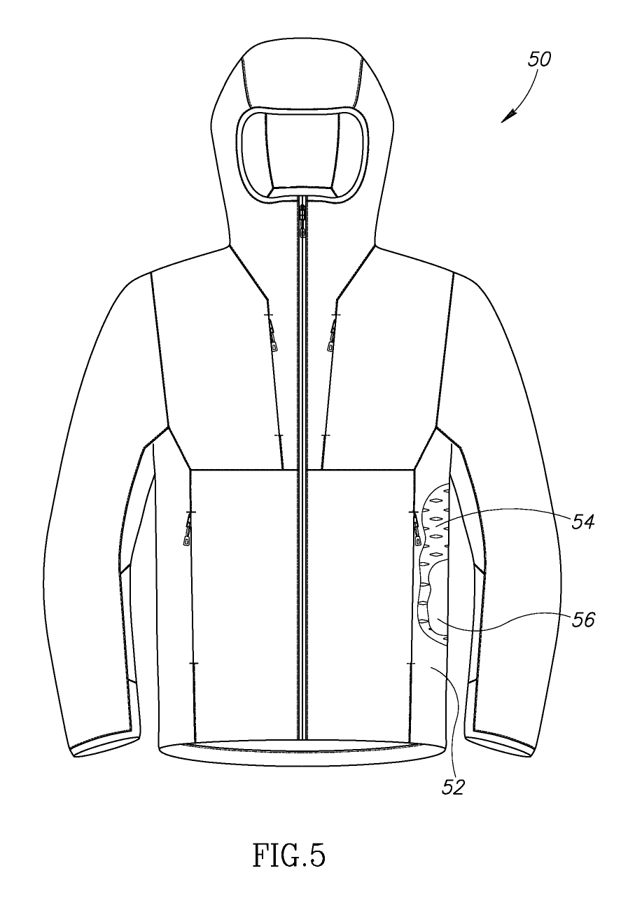

The stretching and relaxing can also create somewhat of a pumping action of air and/or moisture through the insulating material. This pumping may aid in moisture transfer and cooling during times of high activity. As noted previously, the insulating material of the present embodiment may be disposed in an array of material forming the construction of a garment. For example, the insulating material may be disposed between an outer layer of a nonporous material and a layer of an inner material in a similar fashion to that depicted in FIG. 5, described in greater detail herein. In such case, insulation loft is increased by stretching the insulating material, while the outer and inner layers function to retain warm air within the garment, to provide durability, to provide a water resistance, and/or to provide a wind-block function.

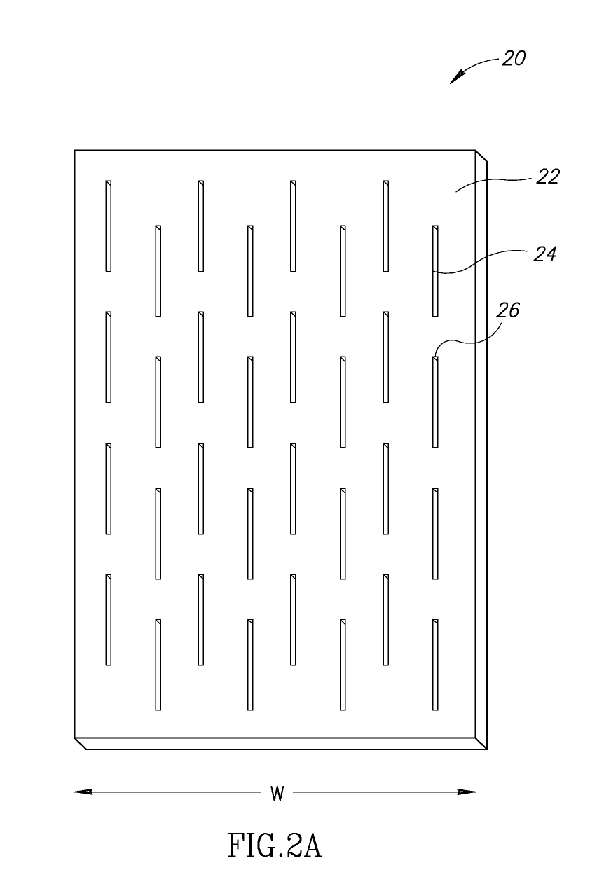

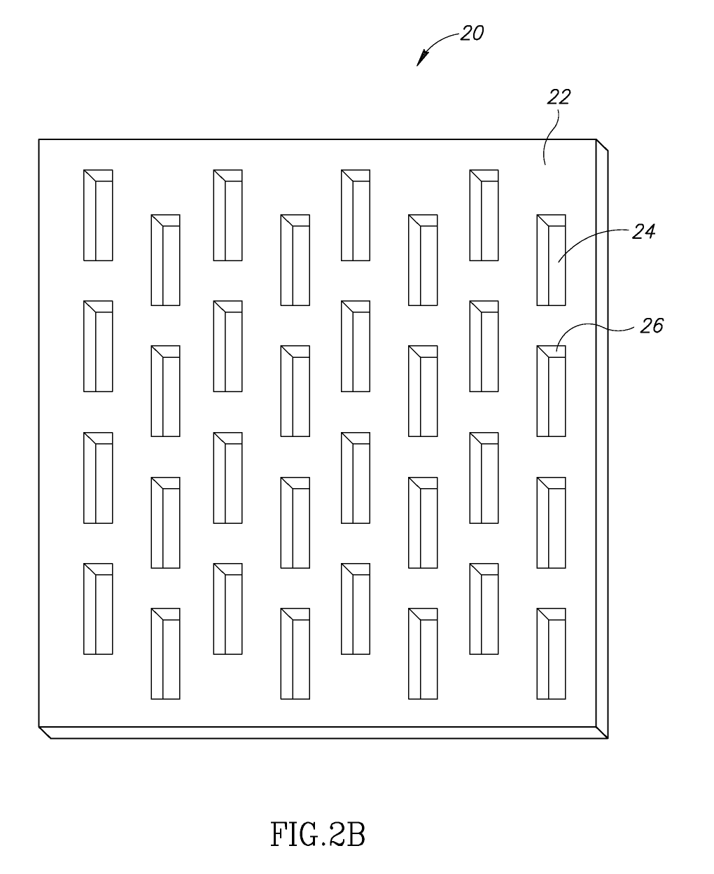

FIGS. 2A-2B depict a compressible, low-weight insulating material 20 of the present invention at rest (FIG. 2A) and stretched along a width (FIG. 2B). In FIG. 2A, an outer surface of an elastic insulating material 22 with a resting width W defines a plurality of rectangular slits (e.g., 24). The slits 24 extend in a linear or substantially linear fashion through the elastic insulating material and are defined by interior walls (e.g., 26) of the elastic insulating material 22. In the present embodiment, opposing interior walls 26 that define a given slit 24 are parallel or are substantially parallel to one another. It will be appreciated that such parallel walls may provide a more consistent elasticity to the insulating material 20. In FIG. 2B, the insulating material 20 of FIG. 2A is stretched along its width W to open the plurality of rectangular slits 24, increasing the negative space defined by the insulating material 20 and permitting increased transfer of heat, moisture, and or/air from the inner surface (not shown) to the outer surface of the elastic insulating material 22.

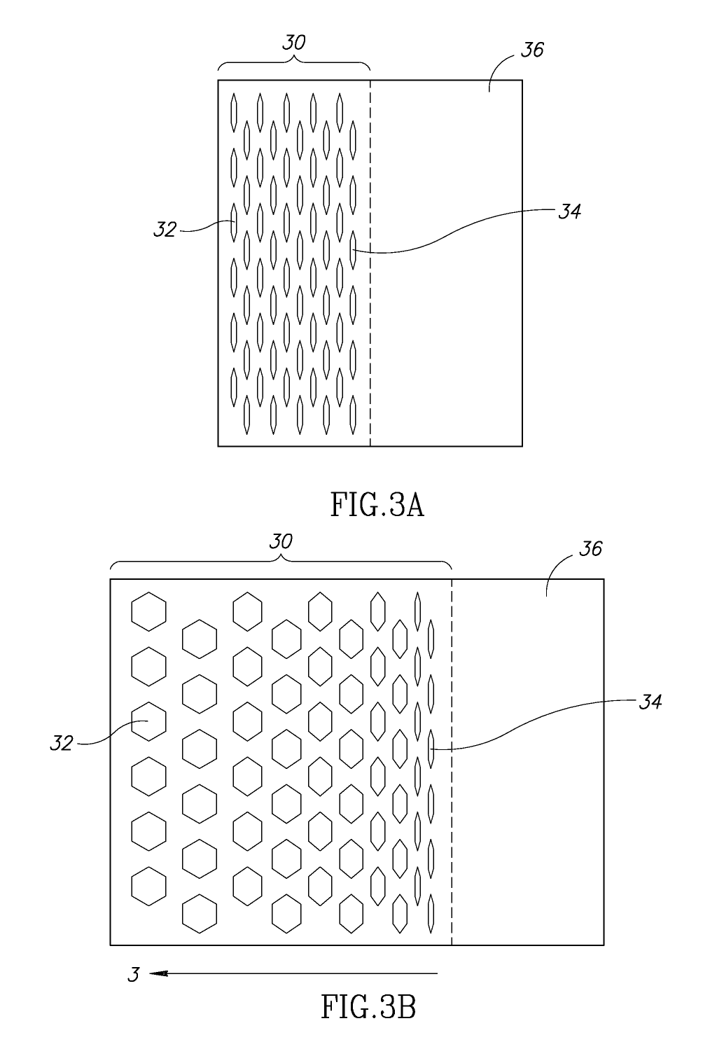

In another aspect of the present invention, a garment for use by a wearer comprises a compressible, low-weight insulating material. To facilitate stretching and relaxation of the insulating material, the insulating material may be formed or placed adjacent to a more stretch-resistant portion of the same material, such as a braided or quilted portion of the insulating material, or of a different stretch-resistant material. FIG. 3A depicts a compressible, low-weight insulating material 30 of the present invention at rest, attached and adjacent to a stretch-resistant material 36. As can be seen when the insulating material 30 is at rest, a perforation 32 that is distal to the stretch-resistant material 36 is of an equal or an approximately equal size to a perforation 34 that is proximal to the stretch-resistant material 36.

In FIG. 3B, the compressible, low-weight insulating material 30 of FIG. 3A is stretched in the direction of arrow 3. It will be appreciated that in use, the stretch-resistant material 36 will be held substantially in a relative position by a tensile or anchoring force, such as additional material wrapping around the contours of a wearer's body. Due to the difference in elasticity between the insulating material 30 and the stretch-resistant material 36, a perforation 32 that is distal to the stretch-resistant material 36 opens wider than a perforation 34 that is proximal to the stretch-resistant material 36 when the insulating material 30 is stretched away from the stretch-resistant material 36. When the stretching force relaxes (e.g., the wearer's body returns to a resting state from a state of motion), the insulating material 30 returns to the relaxed configuration shown in FIG. 3A.

FIGS. 4A-4C depict front (4A), rear (4B), and left side (4C) views of an insulating layer 40 of a garment of the present invention. Panels 42, 43, 44, 45, 46, 47 of a compressible, low-weight insulating material of the present invention may be placed strategically in areas of the garment that correspond to portions of a wearer's body that move and stretch and/or are known to generate heat during physical activities. In the case of a jacket, panels of the compressible, low-weight insulating material may be placed, for example, along areas of the insulating layer 40 corresponding to a wearer's mouth and nose 42, neck 43, left 44 and right 46 underarms and side body regions, and shoulders 45, 47.

FIG. 4C depicts a left side of the insulating layer 40 of a jacket garment of the present invention with the left arm raised. In this position, the panel of compressible, low-weight insulating material stretches chiefly along the arm and side body regions of the insulating layer 40. As can be seen, perforations defined along the armpit region 44b are wider and more open than perforations defined along the tricep 44c or ribcage regions 44a. As the wearer pumps his or her arms during an activity such as hiking or ice climbing, heat and moisture built up under the arm may be advantageously released across widened perforations. When the wearer comes to a resting position (e.g., the arm is no longer raised and/or pumping), the perforations return to a narrowed configuration to retain warmth within the jacket.

Multiple panels of a compressible, low-weight insulating material of the present invention are placed at different locations along an insulating layer of a garment such that a pumping effect, like that of a bellows, is created by movement of the wearer. As the wearer of a jacket with insulating layer 40 pumps his or her left and right arms during an activity, perforated insulating material corresponding to the right underarm and ribcage region 46 and shoulder 47 and the left underarm and ribcage 44 and shoulder 45 of the jacket 40 expands and contracts to permit or improve airflow through the jacket. When movement of one arm is offset from movement of the other arm (e.g., during hand-over-hand climbing), widening and narrowing of perforations on opposing sides of the wearer's body can serve to pump air from one side of the body to another. Increased air circulation across the interior of the garment and from the interior of the garment to the outside environment may relieve or prevent undesirable buildup of heat and moisture.

FIG. 5 depicts an insulated garment 50 of the present invention. A garment, such as a jacket, may be constructed of three or more unique layers, including an outer layer 52, an insulating layer 54, and an inner layer 56. The outer layer 52 may be nonporous to provide a waterproof or water-resistant shell, while the inner layer 56 may be designed to move comfortably against the wearer's body. Underneath the left arm of the insulated jacket garment 50, successive layers are cut away to reveal a compressible, low-weight insulating layer 54 of the present invention and an inner material layer 56.

At least the outer 52 and inner 56 layers are secured together by stitching, heat-sealing, taping, or other methods known to those of skill in the art to hold the insulating layer 54 in place and form the garment 50. The insulating layer 54 may also be secured to one or both of the outer 52 and inner 56 layers. It will be understood that any of the compressible, low-weight insulating materials described herein, including those depicted in FIGS. 1A-3B, may be used to form the insulating layer 54 of the garment 50. It will also be appreciated that the insulating material of the present invention may be placed in a variety of locations along the garment 50, such as, but not limited to, the locations depicted in FIGS. 4A-4C.

While the preferred embodiments of the invention have been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

1. A compressible insulating material for use in a garment, comprising:
an insulating material, wherein portions of the insulating material are removed or cut so as to provide increased breathability and warmth-to-weight ratio and a decreased compression profile relative to the insulating material when fully intact.

2. The compressible, insulating material of claim 1, wherein the removed or cut portions define perforations, the perforations being configured and arranged to retain heat within the insulating material.

3. The compressible, insulating material of claim 1, wherein the removed or cut portions define recesses, the recesses being configured and arranged to retain heat within the insulating material.

4. The compressible, insulating material of claim 1, wherein the removed or cut portions define slits, the slits being configured and arranged to retain heat within the insulating material.

5. The compressible, insulating material of claim 1, wherein the insulating material is a single-layer elastic insulating material, the elastic insulating material defining an inner surface directed to an inner side of the garment as worn and an outer surface directed to an outer side of the garment as worn, wherein portions of at least one of the inner surface and the outer surface are removed or cut to so as to increase heat transfer across the elastic insulating material when the elastic insulating material is stretched and to decrease heat transfer across the elastic insulating material when the elastic insulating material is at rest.

6. The insulating material of claim 5, wherein the elastic insulating material defines a plurality of perforations from the inner surface through to the outer surface.

7. The insulating material of claim 5, wherein the elastic insulating material defines a plurality of scored lines along at least one of the inner surface and the outer surface.

8. The insulating material of claim 5, wherein the elastic insulating material defines a plurality of recesses along at least one of the inner surface and the outer surface.

9. The insulating material of claim 6, wherein a perforation of the plurality of perforations defines a continuous linear path through the elastic insulating material.

10. The insulating material of claim 6, wherein the elastic insulating material is composed of a single material.

11. The insulating material of claim 6, wherein at least some of the elastic insulating material that is adjacent to a perforation of the plurality of perforations is fused.

12. An insulating material array for use in a garment, comprising:
an outer material directed to the outer surface of a garment as worn;
an inner material directed to the inner surface of a garment as worn; and,
an elastic insulating material disposed between the outer material and the inner material, the elastic insulating material defining an inner surface directed to an inner side of the garment as worn and an outer surface directed to an outer side of the garment as worn, wherein at least one of the inner surface and the outer surface is adapted to decrease heat transfer across the elastic insulating material when the elastic insulating material is stretched and to increase heat transfer across the elastic insulating material when the elastic insulating material is relaxed.

13. The insulating material array of claim 12, wherein at least one of the inner surface and the outer surface is adapted to form a protrusion, wherein the protrusion expands away from the given surface when the elastic insulating material is stretched, thereby increasing the loft of the elastic insulating material, and wherein the protrusion contracts toward the given surface when the elastic insulating material is relaxed, thereby decreasing the loft of the elastic insulating material.

14. The insulating material array of claim 13, wherein at least one of the inner surface and the outer surface defines a scallop-shaped slit, wherein the elastic insulating material defining the scallop-shaped slit is configured and arranged to form the protrusion.

15. An insulated garment, comprising:
an inner material layer;
an outer material layer; and,
the insulating material of claim 5, wherein the insulating material is disposed between the inner material layer and the outer material layer and wherein the inner material layer and the outer material layer are secured together to form an insulated garment.

16. The insulated garment of claim 15, wherein a first portion of the insulating material is disposed along a region of the garment that stretches with movement of a wearer during use.

17. The insulated garment of claim 16, further comprising a stretch-resistant material secured to the portion of the insulating material.

18. The insulated garment of claim 16, wherein the stretch-resistant material is the same material as the elastic insulating material and is adapted to resist stretching.

19. The insulated garment of claim 16, wherein a second portion of the insulating material is disposed along another region of the garment, and wherein the perforations of the first and the second portions widen and narrow during use of the garment by a wearer.

20. The insulated garment of claim 15, wherein the garment is a jacket.
